(19) United States
(12) Patent Application Publication
(10) Pub. No.: US 2009/0161882 A1
(43) Pub. Date: Jun. 25, 2009

(54) Method of Measuring an Audio Signal Perceived Quality Degraded by a Noise Presence

(76) Inventors: Nicolas Le Faucher, Rospez (FR); Valerie Gautier-Turbin, Louannec (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/086,299

(22) PCT Filed: Dec. 8, 2006
(86) PCT No.: PCT/FR2006/051310

§ 371 Date: Jan. 21, 2009

(30) Foreign Application Priority Data
Dec. 9, 2005 (FR) 0553807

(51) Int. Cl. H04R 29/00; G10L 19/00

(52) U.S. Cl. 381/56; 704/200.1; 704/E19.001

(57) ABSTRACT

A method of calculating an objective score (NOS) of the perceived quality of an audio signal degraded by the presence of noise and processed by a noise reducing function, said method comprising a preliminary step of obtaining a predefined test audio signal (x[m]) containing a wanted signal free of noise, a signal (xb[m]) affected by noise obtained by adding a predefined noise signal to the test signal (x[m]), and a processed signal (y[m]) obtained by applying the noise reducing function to the signal (xb[m]) affected by noise. This method includes a step (a5) of measuring distances (d_{YX}(m,b)) between perceived loudness densities calculated for the processed signal (y[m]) and perceived loudness densities calculated for the test signal (x[m]); and a step (a6) of comparing said distances (d_{YX}(m,b)) with masking thresholds (S_{masking}(m,b)) calculated for the test signal (x[m]) and/or the processed signal (y[m]).

The general fields of the present invention are those of speech signal processing and psychoacoustics. The invention relates more precisely to a method and a device for objectively evaluating the perceived quality of audio signals degraded by the presence of noise, especially when such audio signals are processed by a noise reduction function.

In the field of audio signal transmission, a noise reduction function, also referred to as a noise cancellation function or a denoising function, has the objective of reducing the level of background noise in speech communication or in communication with a voice component. It is of particular interest when one of the participants in such communication is in a noisy environment that strongly degrades the intelligibility of his voice. Noise reducing algorithms use a continuous estimation of the background noise level based on the incoming signal and voice activity detection to distinguish periods in which only noise is present from those in which the wanted speech signal is also present. The incoming speech signal, corresponding to the speech signal affected by noise, is then filtered to reduce the contribution of the noise as determined from the estimate of the noise.

The perceived quality of a voice signal degraded by the presence of noise is nowadays subjectively evaluated exclusively by processing results of tests defined in ITU-T Recommendation P.835 (11/2003). This evaluation is effected on a mean opinion score (MOS) scale, which gives the degraded voice signal, which is referred to as the speech signal in the above document, a score from 1 to 5. French patent application FR0501747 previously filed by the applicant proposes a solution for measuring the nuisance effect of noise in an audio signal. However, that solution is based on obtaining an objective score of the nuisance caused by noise in an audio signal, corresponding to the background score referred to in ITU-T Recommendation P.835, and not on obtaining an objective score for the audio signal itself, as such scores prove to be more complex to define.

The major drawback of the current technique for evaluating the perceived quality of a degraded audio signal is the necessity to use subjective tests, which are laborious and very costly. This is because each particular context, i.e. one type of incoming signal associated with one type of noise and one noise reducing function, requires setting up a panel of people to listen to real to speech samples and score the degraded signals on an MOS scale.

This is why there is much interest in developing alternative objective methods that can complement or supplant subjective methods. The most striking illustration of this phenomenon is the constantly evolving listening quality model defined in ITU-T Recommendation P.862 (02/2001) and ITU-T Recommendation P.862.1 (11/2003). However, this model does not evaluate the perceived quality of an audio signal degraded by the presence of noise. This is because using this model in an attempt to score objectively an audio signal degraded by the presence of noise yields results having only a very low correlation with speech signal scores on the MOS scale obtained with the corresponding subjective tests of ITU-T Recommendation P.835.

An object of the present invention is to remove the drawbacks of the prior art by providing a method and a device for objectively calculating a score equivalent to the subjective score defined in the document ITU-T Recommendation P.835 and characterizing the perceived quality of an audio signal degraded by the presence of noise. The method of the invention applies equally to any audio signal affected by noise and to an audio signal affected by noise that has been processed by a noise reducing function, in particular in terms of the parameters for calculating the objective score according to the invention. Although the invention is generally used to evaluate the perceived quality of a degraded audio signal at the output of a communication device implementing a noise reducing function, the invention also applies to signals affected by noise that have not been processed by any such function. Using the invention on any audio signal affected by noise is therefore a special case of the more general case of using the invention on an audio signal affected by noise that has been processed by a noise reducing function. To explain these two uses clearly, two implementations are described. However, the second implementation, applying to any audio signal affected by noise, is readily deduced from the first implementation. Below, if the implementation is not specified, the expression “degraded audio signal” refers to the evaluated audio signal, i.e. the processed signal in the first implementation or the signal affected by noise in the second implementation.

To this end, a first implementation of the invention proposes a method of calculating an objective score of the perceived quality of an audio signal degraded by the presence of noise and processed by a noise reducing function, said method comprising a preliminary step of obtaining a predefined test audio signal containing a wanted signal free of noise, a signal affected by noise obtained by adding a predefined noise signal to the test signal, and a processed signal obtained by applying the noise reducing function to the signal affected by noise, said method being characterized in that it includes:
a step of measuring distances between perceived loudness densities calculated for the processed signal and perceived loudness densities calculated for the test signal; and
a step of comparing said distances with masking thresholds calculated for the test signal and/or the processed signal.

This method has the advantage of simple, immediate and fast implementation, in contrast to subjective tests. It can be implemented in software on a computer or integrated into a device for measuring the performance of noise reducing functions. The expression “psychoacoustic perceived loudness” can be defined as the character of the auditory sensation linked to the sound pressure level and to the structure of the sound. In other words, it is the intensity of a sound or a noise qua an auditory sensation (Office de la langue francaise, 1988). Perceived loudness is represented in sones on a psychoacoustic perceived loudness scale. In other words, the perceived loudness density, also referred to as the “subjective intensity”, is a particular measurement of the perceived loudness.

According to a preferred feature, the first implementation of the method of the invention includes the steps of:
detecting voice activity in the test signal;
calculating perceived loudness densities for the processed signal, the signal affected by noise, and the test signal;
calculating masking thresholds for the processed signal and/or the test signal;
calculating the distances between said perceived loudness densities of the processed signal and said perceived loudness densities of the test signal and the distances between said perceived loudness densities of the processed signal and said perceived loudness densities of the signal affected by noise;
partitioning the distances calculated in this way between the perceived loudness densities of the processed signal and the perceived loudness densities of the test signal by comparison with said masking thresholds;
calculating mean values of the distances partitioned in this way as a function of said partitioning and the result of the voice activity detection in order to obtain parameters characteristic of different types of deterioration caused by noise in the processed signal; and
calculating an objective score for the processed signal using the parameters obtained in this way, the distances calculated in the distance calculation step, and subjective data obtained from a test database.

The partitioning step, which uses masking thresholds and distances calculated for the test and processed signals, takes account of different kinds of deterioration of the processed signal and therefore produces an objective score for the processed signal that is very close to the subjective score that would be produced by subjective tests.

A second implementation of the invention consists in a method of calculating an objective score of the perceived quality of an audio signal degraded by the presence of noise, said method comprising a preliminary step of obtaining a predefined test audio signal containing a wanted signal free of noise and a signal affected by noise obtained by adding a predefined noise signal to the test signal, said method being characterized in that it includes:
a step of measuring distances between perceived loudness densities calculated for the signal affected by noise and perceived loudness densities calculated for the test signal; and
a step of comparing said distances with masking thresholds calculated for the signal affected by noise and/or the test signal.

The advantages of this second implementation of the invention are similar to those of the first implementation of the invention, but this second implementation applies to any audio signal affected by noise.

According to a preferred feature, the second implementation of the method of the invention includes the steps of:
detecting voice activity in the test signal;
calculating perceived loudness densities for the signal affected by noise and the test signal;
calculating masking thresholds for the signal affected by noise and/or the test signal;
calculating the distances between said perceived loudness densities of the test signal and said perceived loudness densities of the signal affected by noise;
partitioning the distances calculated in this way by comparison with said masking thresholds;
calculating mean values of the distances partitioned in this way as a function of said partitioning and the result of the voice activity detection in order to obtain parameters characteristic of different types of deterioration caused by noise in the signal affected by noise; and
calculating an objective score for the signal affected by noise using the parameters obtained in this way, the distances calculated in this way, and subjective data obtained from a test database.

The partitioning step takes account of different kinds of deterioration of the signal affected by noise and therefore produces an objective score for the signal affected by noise that is very close to the subjective score that would be produced by subjective tests.

According to a preferred feature of these implementations of the invention, the partitioning step is followed by a step of classifying the degraded audio signal as a function of the types of deterioration present in said signal, the calculation of the objective score taking account of this classification.

Classifying the degraded audio signal adapts the calculation of the objective score for the degraded audio signal to the particular deterioration of that audio signal, in order to produce an objective score that is even closer to that which would be produced by subjective tests.

According to another preferred feature, the step of calculating mean values is preceded by a step of changing the frame timing.

This step makes it possible to process longer frames, more representative of the periods over which a listener would perceive the degraded audio signal during subjective tests.

According to another preferred feature, the step of calculating the objective score is followed by a step of calculating an objective score on the MOS scale of the perceived quality of the degraded audio signal.

This step produces an objective score for the degraded audio signal on the same standard scale as the subjective tests of ITU-T Recommendation P.835.

According to another preferred feature, the calculation of the masking thresholds of an audio signal frame uses a model that is a hybrid of the Johnston masking model and the ISO (International Standards Organization) masking model.

Using this hybrid model reduces the number of calculations compared to using only the ISO masking model when implementing the method of the invention.

The invention also provides a test device for evaluating an objective score of the perceived quality of an audio signal degraded by the presence of noise, characterized in that it includes means adapted to implement the method according to one implementation of the invention.

The invention further provides a computer program on an information medium, including instructions adapted to implement the method according to one implementation of the invention when said program is loaded into and executed by a data processing system.

The advantages of the above test device and the above computer program are identical to those referred to above with reference to either implementation of the method of the invention.

Other features and advantages become apparent on reading the description of the preferred implementations given with reference to the figures, in which:

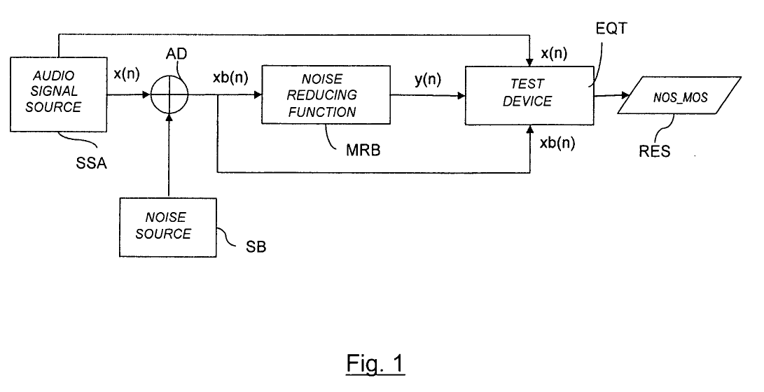

FIG. 1 represents a test environment for calculating an objective score for the perceived quality of an audio signal degraded by the presence of noise and processed by a noise reducing function using a first implementation of the invention;

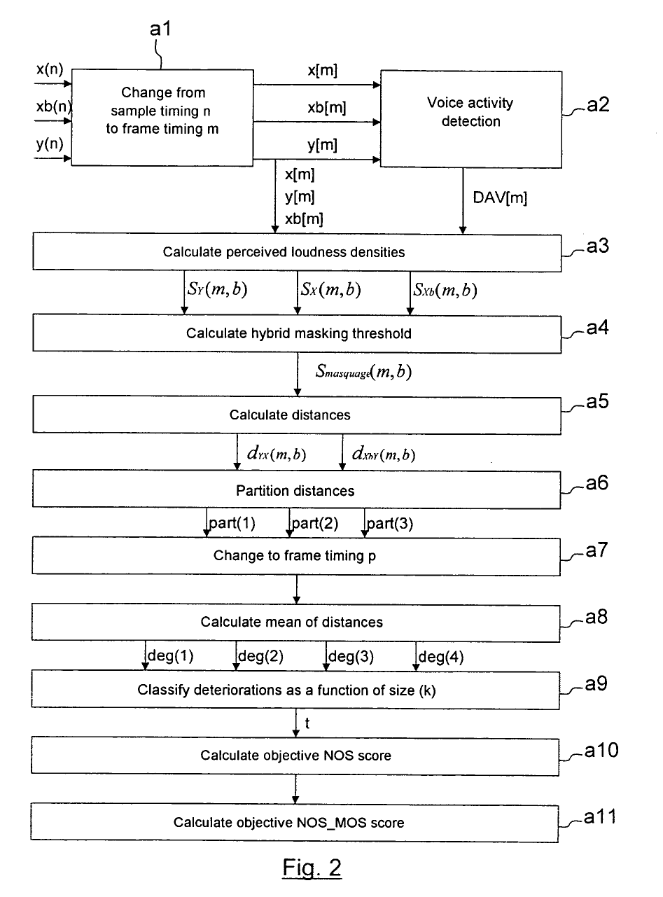

FIG. 2 is a flowchart showing a method of calculating an objective score for the perceived quality of an audio signal degraded by the presence of noise and processed by a noise reducing function using a first implementation of the method of the invention;

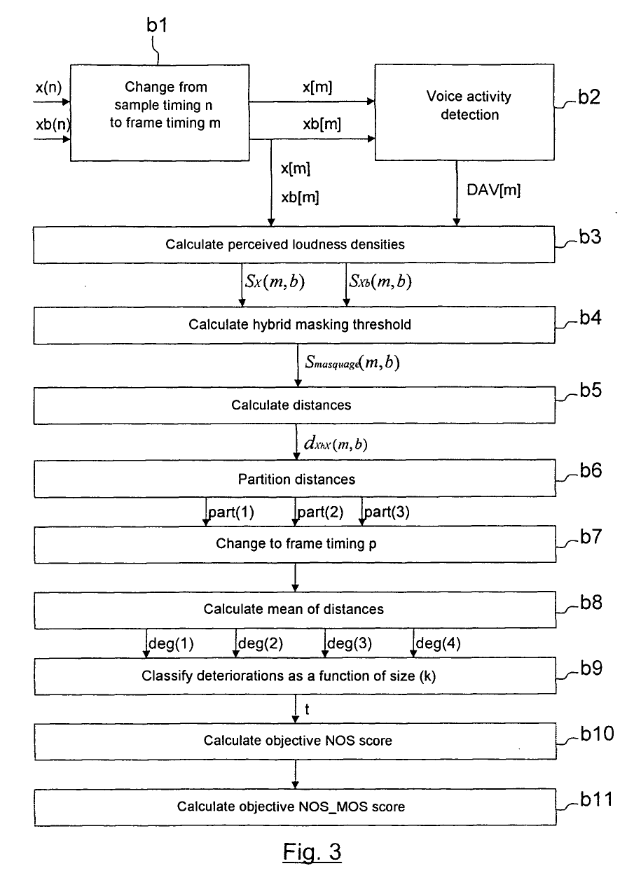

FIG. 3 is a flowchart showing a method of calculating an objective score for the perceived quality of an audio signal degraded by the presence of noise using a second implementation of the method of the invention;

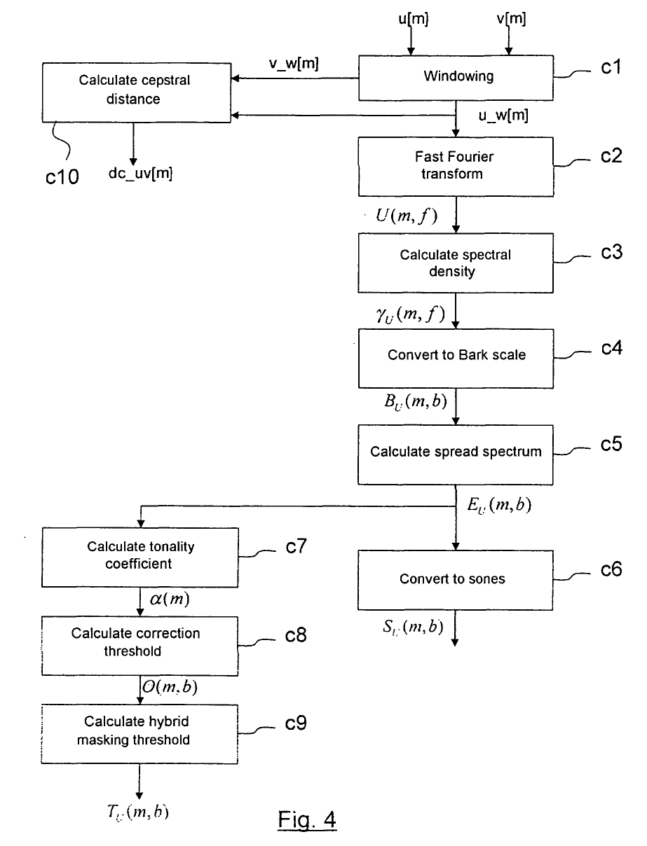

FIG. 4 is a flowchart showing a method of calculating the perceived loudness density and the masking threshold of an audio signal frame and calculating the cepstral distance between two corresponding frames of two audio signals using the invention.

Two implementations of the method of the invention are described below, the first being applicable to an audio signal affected by noise processed by a noise reducing function and the second being applicable to any audio signal affected by noise. The theory of the method of the invention is the same in both implementations, and in particular the calculation method is exactly the same, but in the second implementation the audio signal processed by a noise reducing function is taken as equal to the signal affected by noise. The second implementation can be considered a special case of the first implementation, with the noise reducing function disabled.

In a first implementation of the method of the invention the perceived quality of an audio signal degraded by the presence of noise and processed by a noise reducing function is evaluated objectively in a test environment represented in FIG. 1. Such test environments comprise an audio signal source SSA delivering a test audio signal x(n) containing only the wanted signal, i.e. free of noise, for example a speech signal, and a noise source SB delivering a predefined noise signal.

For test purposes, the predefined noise signal is added to the chosen test signal x(n), as represented by the addition operator AD. The audio signal xb(n) resulting from this addition of noise to the test signal x(n) is referred to as “the signal affected by noise”.

The signal xb(n) affected by noise constitutes the input signal of a noise reduction module MRB implementing a noise reducing function delivering at the output an audio signal y(n) referred to as the “processed signal”. The processed signal y(n) is therefore an audio signal containing the wanted signal and residual noise.

The processed signal y(n) is then delivered to a test device EQT implementing a method of the invention for objective evaluation of the perceived quality of the processed signal. The method of the invention is typically implemented in the test device EQT in the form of a computer program. In addition to or instead of software means, the test device EQT can include electronic hardware means for implementing the method of the invention. Apart from the signal y(n), the test device EQT receives at its input the test signal x(n) and the signal xb(n) affected by noise.

The test device EQT delivers at its output an evaluation result RES in the form of an objective NOS_MOS score of the perceived quality of the processed signal y(n). How this objective NOS_MOS score is calculated is described below.

The aforementioned audio signals x(n), xb(n), and y(n) are sampled signals in a digital format, n denoting any sample. These signals are sampled at a sampling frequency of 8 kHz (kilohertz), for example.

In the implementation shown and described here, the test signal x(n) is a speech signal free of noise. The signal xb(n) affected by noise then represents the original voice signal x(n) degraded by a noisy environment (background noise or ambient noise), and the signal y(n) represents the signal xb(n) after noise reduction.

In one implementation of the invention, the signal x(n) is generated in an anechoic chamber. However, the signal x(n) can also be generated in a “quiet” room having a “medium” reverberation time, less than 0.5 second.

The signal xb(n) affected by noise is obtained by adding a predetermined contribution of noise to the signal x(n). The signal y(n) is obtained either on exit from a noise reducing algorithm installed on a personal computer or at the output of a noise reducing network equipment; the signal y(n) from noise reducing network equipment is sampled in a pulse code modulation (PCM) coder.

Referring to FIG. 2, the method of the invention of calculating the objective NOS_MOS score for the perceived quality of the processed signal y(n) is represented in the form of an algorithm including steps a1 to a11.

In a step al, the signals x(n), xb(n), and y(n) are respectively divided into successive time windows called frames. Each signal frame m contains a predetermined number of samples of the signal and the step a1 therefore consists in changing the timing of each of these signals. Changing the timing of the signals x(n), xb(n), and y(n) to the frame timing produces signals x[m], xb[m], and y[m], respectively, where m is the index of the frame concerned.

Thereafter, a set of frames is processed. For example, if 8 seconds of test signal sampled at 8 kHz are used, 250 frames x[m] of 256 signal samples x(n) can be processed. Moreover, the calculated values are calculated over each frame m from this set of frames and therefore all have a frame index m.

In a step a2, voice activity detection (VAD) is applied to the signal x[m] to determine if each respective current frame of index m of the signals xb[m] and y[m] is a frame containing only noise or a frame containing speech, i.e. wanted signal. This is determined by comparing the signals xb[m] and y[m] with the test signal x[m] free of noise. Each frame of silence of x[m] corresponds temporally to a noise frame for the signals xb[m] and y[m] while each speech frame of x[m] corresponds to a speech frame for the signals xb[m] and y[m].

Following the step a2, the variable VAD[m] represented in FIG. 2, which is the result of the voice activity detection, has the value 1 for the speech frames of x[m], y[m], and xb[m] and the value 0 for the silence frames of x[m] and the noise frames of xb[m] and y[m].

In a step a3, perceived loudness measurements are effected on the frames of the signals x[m], xb[m], and y[m], whatever the results of voice activity detection for those frames. The cepstral distance dc_xy[m] between the frames m of the signals x[m] and y[m] is also calculated.

To be more precise, in this step, the perceived loudness densities S_{Y}(m,b), S_{X}(m,b), and S_{Xb}(m,b) of the respective frames y[m], x[m], and xb[m] are calculated, where b is the number of a critical band in the Barks domain. In this implementation, the sampling frequency being 8 kHz, 18 critical bands are processed and 18 perceived loudness density values are therefore calculated for each frame m. Thereafter, calculated values having the critical band index b are calculated for each of the 18 critical bands considered.

The calculation of the perceived loudness densities Sᵤ(m,b) of any frame m of a given audio signal u and the calculation of the cepstral distance dc_uv[m] between any frame m of a given audio signal u and the frame m of a given audio signal v are described in detail below with reference to FIG. 4.

In a step a4, the hybrid masking thresholds of the signals x[m] and y[m] are calculated. There is then obtained for each frame m and each critical band b a global hybrid mask threshold S_{masking}(m,b) for the processed signal, taking the minimum of the thresholds calculated on the signals x[m] and y[m] according to the following equation:

S_{masking}(m,b)=min(T_{X}(m,b),T_{Y}(m,b)

where
min(p,q) is the minimum of the variables p and q;
T_{X}(m,b) is the hybrid masking threshold of the signal x[m] for the frame m and the critical band b; and
T_{Y}(m,b) is the hybrid masking threshold of the signal y[m] for the frame m and the critical band b.

Alternatively, the hybrid masking threshold S_{masking}(m,b) is taken as equal to the hybrid masking threshold of the signal x[m] or the signal y[m], these two thresholds being in practice very close together.

The calculation of the hybrid masking threshold Tᵤ(m,b) of a frame m in the critical band b of a given audio signal u is described in detail below with reference to FIG. 4.

Alternatively, the masking threshold S_{masking}(m,b) is taken as equal to the minimum masking threshold calculated for the signals x[m] and y[m], either using the masking threshold model of J. D. Johnston described in his paper “Transform coding of audio signals using perceptual noise criteria” IEEE Journal on selected areas in communications, Vol. 6, No. 2, February 1988, or using the masking threshold defined in psychoacoustic model number 1 from the ISO standard. It is equally possible, in the method of the invention, to take the masking threshold S_{masking}(m,b) as equal to the Johnston masking threshold of the signal x[m], the Johnston masking threshold of the signal y[m], the ISO masking threshold of the signal x[m] or the ISO masking threshold of the signal y[m]. In practice, it is preferable to use the hybrid model to calculate the masking threshold S_{masking}(m,b) because, being less complex in terms of calculations than the ISO model and more accurate than the Johnston model, this model represents a compromise between the Johnston model and the ISO model.

Using a masking threshold means that deterioration below that threshold can be considered not to be perceived by users and therefore need not be counted in the perceived deterioration, which is taken account of in the step a8.

In a step a5, the mean distances d_{YX}(m,b) and d_{XbY}(m,b) are calculated between the perceived loudness densities of the signal y[m] and the perceived loudness densities of the signal x[m] and between the perceived loudness densities of the signal xb[m] and the perceived loudness densities of the signal y[m], respectively. To be more precise, these distances are given for each frame m and each critical band b by the following equations:

d_{YX}(m,b)=(S_{Y}(m,b)−S_{X}(m,b))

d_{XbY}(m,b)=(S_{Xb}(m,b)−S_{Y}(m,b)

the perceived loudness density values S_{Y}(m,b), S_{X}(m,b), and S_{Xb}(m,b) being those calculated in the step a3.

In a step a6, the distances d_{YX}(m,b) calculated in this way, or more precisely the doublets (m,b), are partitioned by comparison with the hybrid masking thresholds calculated in the step a4. This produces three subsets part(k), k being an index varying from 1 to 3, defined as follows:
The distances belonging to the subset part(1) obey the following conditions:

(d_{YX}(m,b)>0) & (d_{YX}(m,b)>S_{masking}(m,b))
The distances belonging to the subset part(2) obey the following conditions:

(d_{YX}(m,b)>−S_{masking}(m,b)) & (d_{YX}(m,b)<S_{masking}(m,b))
The distances belonging to the subset part(3) obey the following conditions:

(d_{YX}(m,b)<0) & (d_{YX}(m,b)<−S_{masking}(m,b))

In a step a7, there is a change from the timing of the frame n to the timing of the frame p, where p is an integer multiple of the size of a frame m, for example 20 times the size of a frame m. Longer frames are therefore processed at this stage, enabling deterioration of the signal over a period of several hundred milliseconds to be considered. The perceived quality of the processed signal is not representative over too short a time period, and the frames m of 256 samples enable the signal to be perceived over only 16 milliseconds, allowing for the fifty percent overlap of the frames.

In a step a8, weighted mean values are calculated of the absolute values of the distances d_{YX}(m,b) by the corresponding perceived loudness densities S_{X}(m,b). These mean values are calculated for a set P of frames p, p having the value 24, for example, and the 18 critical bands b considered in the Barks domain. They differ as a function of the doublets (m,b) taken into account when calculating them, the doublets being chosen as a function of the subset part(k) to which they belong and as a function of the result of the voice activity detection VAD[m] in the step a2 for the frame m.

Four parameters deg(1), deg(2), deg(3), and deg(4) are obtained in this way, defined by the following equations:

$$deg ( 1 ) = \frac{{\sum }_{p = 1}^{P} ( {\sum }_{b = 1}^{18} ( {\sum }_{{m ∈ p \&}_{{( m , b ) ∈ part ( 1 ) \&}_{DAV ( m ) = 0}}} {S}_{X} ( m , b ) * \vert {d}_{YX} ( m , b ) \vert ) )}{{\sum }_{p = 1}^{P} ( {\sum }_{b = 1}^{18} ( {\sum }_{m ∈ p} {S}_{X} ( m , b ) ) )}$$

$$deg ( 2 ) = \frac{{\sum }_{p = 1}^{P} ( {\sum }_{b = 1}^{18} ( {\sum }_{{m ∈ p \&}_{{( m , b ) ∈ part ( 3 ) \&}_{DAV ( m ) = 1}}} {S}_{X} ( m , b ) * \vert {d}_{YX} ( m , b ) \vert ) )}{{\sum }_{p = 1}^{P} ( {\sum }_{b = 1}^{18} ( {\sum }_{m ∈ p} {S}_{X} ( m , b ) ) )}$$

$$deg ( 3 ) = \frac{{\sum }_{p = 1}^{P} ( {\sum }_{b = 1}^{18} ( {\sum }_{{m ∈ p \&}_{{( m , b ) ∈ part ( 1 ) \&}_{DAV ( m ) = 1}}} {S}_{X} ( m , b ) * \vert {d}_{YX} ( m , b ) \vert ) )}{{\sum }_{p = 1}^{P} ( {\sum }_{b = 1}^{18} ( {\sum }_{m ∈ p} {S}_{X} ( m , b ) ) )}$$

$$deg ( 4 ) = \frac{{\sum }_{p = 1}^{P} ( {\sum }_{b = 1}^{18} ( {\sum }_{{m ∈ p \&}_{DAV ( m ) = 1}} {S}_{X} ( m , b ) * \vert {d}_{YX} ( m , b ) \vert ) )}{{\sum }_{p = 1}^{P} ( {\sum }_{b = 1}^{18} ( {\sum }_{m ∈ p} {S}_{X} ( m , b ) ) )}$$

Each of these parameters corresponds to a type of deterioration, which produces an objective score for the processed signal closer to the subjective test results than if account were to be taken only of a global deterioration of the processed signal caused by noise. Accordingly:

the parameter deg(1) characterizes the residual noise for frames with no voice activity;

the parameter deg(2) characterizes the subtractive deteriorations caused by noise for frames with voice activity;

the parameter deg(3) characterizes the additive deterioration caused by noise for frames with voice activity;

the parameter deg(4) characterizes the overall deterioration caused by noise for frames with voice activity.

In a step a9, the processed signal is classified as a function of the various types of deterioration caused by noise present in the signal. For this, there is calculated for each subset part(k) defined in the step a6 a proportion “size(k)” of the doublets (m,b) for which the distances d_{YX}(m,b) belong to this subset part(k). The proportion size(k), k being the subset index and therefore varying from 1 to 3, is defined by the following equation:

$$size ( k ) = \frac{\begin{matrix}number of doublets ( m , b ) \\ such that \text{:} {d}_{YX} ( m , b ) ∈ part ( k )\end{matrix}}{number of doublets ( m , b )}$$

The number of doublets (m,b) being in this implementation equal to 250 frames m times 18 critical bands b.

The deterioration class t of the processed signal is then obtained by applying the following tests to the proportions size(1) and size(3) obtained beforehand:

(size(1)>0.5) & (size(3)<0.1) [symbol] t=1

(size(1)>0.5) & (0.1<size(3)<0.5) [symbol] t=2

(size(1)>0.5) & (size(3)>0.5) [symbol] t=3

(size(1)<0.5) & (size(3)<0.1) [symbol] t=4

(size(1)<0.5) & (0.1<size(3)<0.5) [symbol] t=5

(size(1)<0.5) & (size(3)>0.5) [symbol] t=6

Accordingly, if the proportion size(1) is greater than 0.5, i.e. the partition part(1) is the majority, which corresponds to a majority additive deterioration, and if the proportion size(3) is less than 0.1, which corresponds to a minority subtractive deterioration, then the deterioration class for the processed signal is class 1. Note that the thresholds used to define these proportions, here having the values 0.1 and 0.5, are examples that can be modified as a function of additional experiments to improve the method of the invention.

Taking account of this classification of the deterioration of the processed signal in the calculation of the next step produces an objective score for the processed signal closer to the corresponding subjective score than if this classification were not taken into account.

In a step a10, an intermediate objective NOS score is calculated using the following linear combination:

$$NOS = ( {\sum }_{i = 1}^{4} ω ( i , t ) * deg ( i ) ) + ω ( 5 , t ) * Standard\_deviation ( {d}_{YX} ( m , b ) ) + ω ( 6 , t ) * Standard\_deviation ( {d}_{XbY} ( m , b ) ) + ω ( 7 , t ) * {( {dc}_{XY} )}_{DAV = 1} + ω ( 8 , t )$$

where:

the parameters deg(i) are those obtained after the step a8;

the operator “Standard_deviation(z(m,b))” designates the standard deviation of the variable z(m,b) over all of the frames m and the critical bands b;

* symbolizes the multiplication operator in the space of real numbers;

+ symbolizes the addition operator in the space of real numbers;

d_{YX}(m,b) and d_{XbY}(m,b) are the mean distances calculated in the step a5;

(dc_{XY})_{DAV=1} designates the mean cepstral distance between the signals x[m] and y[m] calculated for the speech frames of these signals, i.e. the mean cepstral distance dc_xy[m] calculated for the speech frames of the signals x[m] and y[m] in the step a3;

the coefficients ω(1,t) and ω(8,t) are weighting coefficients predefined as a function of each of the six classes of deterioration t.

For example, if the deterioration class t determined in the step a9 has the value 1, the coefficients ω(1,1) to ω(8,1) are used in the calculation of the NOS score. These coefficients were determined to obtain a maximum correlation between subjective data from a subjective test database and objective NOS scores calculated by this linear combination using the test signal x[m], the signal xb[m] effected by noise, and the processed signal y[m] used during the same subjective tests and representative of the six classes of deterioration defined in the step a9. For example, the subjective test database is a database of scores obtained with groups of listeners in accordance with ITU-T Recommendation P.835, in which these scores are referred to as speech signal scores.

Note that obtaining weighting coefficients using a subjective test database is not indispensable for each step of calculating an objective NOS score. These coefficients must be obtained prior to the first use of the method and can be the same for all uses of the method. However, they evolve as new subjective data is fed into the subjective test database used.

Finally, in a final step all, an objective NOS_MOS score on the MOS scale is calculated for the processed signal using a third order polynomial function according to the following equation, for example:

$$NOS\_MOS = {\sum }_{i = 1}^{4} λ ( i , t ) {( NOS )}^{i - 1}$$

in which the coefficients λ(1,t) to λ(4,t) are determined for each deterioration class t of the processed signal so that the objective NOS_MOS score obtained characterizes the processed signal on the MOS scale, i.e. on a scale from 1 to 5.

Using a third order polynomial function produces an objective score on the MOS scale very close to the subjective MOS score that would be obtained from a group of listeners in a subjective test conforming to ITU-T Recommendation P.835.

In a second implementation of the method of the invention, the perceived quality of an audio signal degraded by the presence of noise is evaluated objectively. The same test environment is used as in FIG. 1, but with the noise reduction module MRB removed. The audio signal source SSA delivers a test audio signal x(n) containing only the wanted signal, to which is added a predefined noise signal generated by the noise source SB, to obtain at the output of the addition operator AD a signal xb(n) affected by noise.

The test signal x(n) and the signal xb(n) affected by noise are then sent directly to the input of the test device EQT that uses the method of the invention for objective evaluation of the perceived quality of the degraded audio signal xb(n). As in the first implementation, the signals x(n) and xb(n) are assumed to be sampled at the sampling frequency 8 kHz.

The test device EQT delivers at its output an evaluation result RES in the form of an objective NOS_MOS score for the perceived quality of the degraded audio signal xb(n).

Referring to FIG. 3, the method of the invention for calculating the objective NOS_MOS score for the perceived quality of the degraded audio signal xb(n) is represented in the form of an algorithm comprising steps b1 to b11. These steps are similar to the steps a1 to a11 described above for the first implementation, and are therefore described in slightly less detail. Note that if the calculation steps a1 to all were to be applied with the signal y(n) equal to the signal xb(n) in the first implementation, then the second implementation would result.

In a step b1, the signals x(n) and xb(n) are divided into frames x[m] and xb[m] with temporal index m.

In a step b2, voice activity detection (VAD) applied to the test signal x[m] determines if each respective current frame of index m of the signal xb[m] affected by noise is a frame containing only noise or a frame containing speech. Following the step b2, the result of voice activity detection, i.e. the variable VAD[m] in FIG. 3, has the value 1 for speech frames of the signals x[m] and xb[m] and the value 0 for silence frames of the signal x[m] and noise frames of the signal xb[m].

Below a set of frames is processed. For example, if 8 seconds of test signal sampled at 8 kHz are used, 250 frames x[m] of 256 signal samples x(n) can be processed. Moreover, the values calculated are calculated for each fame m of this set of frames, and therefore all have a frame index m.

In a step b3, the perceived loudness densities S_{X}(m,b) and S_{Xb}(m,b) of the respective frames x[m] and xb[m] are calculated, b being the number of one of the 18 critical bands considered in the Barks domain, and likewise the cepstral distance dc_xxb[m] between the frames m of the signals x[m] and xb[m].

In a step b4, the hybrid masking thresholds of the signals x[m] and xb[m] are calculated for each frame m and each critical band b. The global hybrid masking threshold S_{masking}(m,b) of the signal affected by noise is then obtained by taking the minimum of these thresholds, according to the following equation:

S_{masking}(m,b)=min(T_{X}(m,b), T_{Xb}(m,b))

where min(p,q) is the minimum of the variables p and q, T_{X}(m,b) is the hybrid masking threshold of the signal x[m], and T_{Xb}(m,b) is the hybrid masking threshold of the signal xb[m]. Alternatively, the hybrid masking threshold S_{masking}(m,b) is taken as equal to the hybrid masking threshold of the signal x[m] or the signal xb[m], these two thresholds being very close to each other in practice. Another alternative is for the masking threshold S_{masking}(m,b) to be taken as equal to the minimum of the Johnston masking thresholds or the ISO masking thresholds of the signals x[m] and xb[m]. It is also possible to choose the masking threshold S_{masking}(m,b) to be equal to the Johnston masking threshold or to the ISO masking threshold of the signal x[m] or to the Johnston masking threshold or the ISO masking threshold of the signal y[m].

In a step b5, the average distances d_{XbX}(m,b) between the perceived loudness densities of the signal xb[m] and the perceived loudness densities of the signal x[m] are calculated. To be more precise, these distances are given for each frame m and each critical band b by the following equation, in which the perceived loudness density values S_{X}(m,b) and S_{Xb}(m,b) are those calculated in the step b3:

d_{XbX}(m,b)=(S_{Xb}(m,b)−S_{X}(m,b))

In a step b6, the distances d_{XbX}(m, b) calculated in this way, or to be more precise the doublets(m,b), are partitioned by comparison with the hybrid masking threshold calculated in the step b4. This produces three sub-sets part(k), where k is an index varying from 1 to 3, defined as follows:

The distances belonging to the subset part(1) obey the following conditions:

(d_{XbX}(m,b)>0) & (d_{XbX}(m,b)>S_{masking}(m,b))

The distances belonging to the subset part(2) obey the following conditions:

(d_{XbX}(m,b)>−S_{masking}(m,b)) & (d_{XbX}(m,b)<S_{masking}(m,b))

The distances belonging to the subset part(3) obey the following conditions:

(d_{XbX}(m,b)>0) & (d_{XbX}(m,b)>−S_{masking}(m,b))

Step b7 changes from the frame timing m to a frame timing p, where p is an integer number of times the size of a frame m, for example 20 times the size of a frame m.

Step b8 calculates weighted means of the absolute values of the distances d_{XbX}(m,b) by the corresponding perceived loudness densities S_{X}(m,b). These mean values are calculated over a set P of frames p, P having the value 12, for example, and over the 18 critical bands b considered in the Barks domain. They differ as a function of the doublets (m,b) taken into account in calculating them, which are chosen as a function of the subsets part(k) to which they belong and as a function of the result VAD[m] of voice activity detection, as determined in the step a2, for the frame m.

This produces four parameters deg(1), deg(2), deg(3), and deg(4), defined by the following equations:

$$deg ( 1 ) = \frac{{\sum }_{p = 1}^{P} ( {\sum }_{b = 1}^{18} ( {\sum }_{{m ∈ p \&}_{{( m , b ) ∈ part ( 1 ) \&}_{DAV ( m ) = 0}}} {S}_{X} ( m , b ) * \vert {d}_{YX} ( m , b ) \vert ) )}{{\sum }_{p = 1}^{P} ( {\sum }_{b = 1}^{18} ( {\sum }_{m ∈ p} {S}_{X} ( m , b ) ) )}$$

$$deg ( 2 ) = \frac{{\sum }_{p = 1}^{P} ( {\sum }_{b = 1}^{18} ( {\sum }_{{m ∈ p \&}_{{( m , b ) ∈ part ( 3 ) \&}_{DAV ( m ) = 1}}} {S}_{X} ( m , b ) * \vert {d}_{XbX} ( m , b ) \vert ) )}{{\sum }_{p = 1}^{P} ( {\sum }_{b = 1}^{18} ( {\sum }_{m ∈ p} {S}_{X} ( m , b ) ) )}$$

$$deg ( 3 ) = \frac{{\sum }_{p = 1}^{P} ( {\sum }_{b = 1}^{18} ( {\sum }_{{m ∈ p \&}_{{( m , b ) ∈ part ( 1 ) \&}_{DAV ( m ) = 1}}} {S}_{X} ( m , b ) * \vert {d}_{XbX} ( m , b ) \vert ) )}{{\sum }_{p = 1}^{P} ( {\sum }_{b = 1}^{18} ( {\sum }_{m ∈ p} {S}_{X} ( m , b ) ) )}$$

$$deg ( 4 ) = \frac{{\sum }_{p = 1}^{P} ( {\sum }_{b = 1}^{18} ( {\sum }_{{m ∈ p \&}_{DAV ( m ) = 1}} {S}_{X} ( m , b ) * \vert {d}_{XbX} ( m , b ) \vert ) )}{{\sum }_{p = 1}^{P} ( {\sum }_{b = 1}^{18} ( {\sum }_{m ∈ p} {S}_{X} ( m , b ) ) )}$$

As in step a8, each of these parameters corresponds to a type of deterioration, which produces an objective score for the degraded signal closer to the results of subjective tests than if only overall deterioration by noise of the signal affected by noise were to be taken into account.

A step b9 classifies the signal affected by noise as a function of the various types of deterioration caused by the noise present in the signal. To this end there is calculated for each subset part(k) defined in the step b6 a proportion size(k) of doublets (m,b), k varying from 1 to 3, defined by the following equation:

$$size ( k ) = \frac{\begin{matrix}number of doublets ( m , b ) \\ such that \text{:} {d}_{XbX} ( m , b ) ∈ part ( k )\end{matrix}}{number of doublets ( m , b )}$$

the number of doublets (m,b) being equal to 250 frames m times 18 critical bands b in this implementation.

The deterioration class t of the signal affected by noise is then obtained by applying the following tests to the proportions size(1) and size(3) previously obtained:

(size(1)>0.5) & (size(3)<0.1) [symbol] t=1

(size(1)>0.5) & (0.1<size(3)<0.5) [symbol] t=2

(size(1)>0.5) & (size(3)>0.5) [symbol] t=3

(size(1)<0.5) & (size(3)<0.1) [symbol] t=4

(size(1)<0.5) & (0.1<size(3)<0.5) [symbol] t=5

(size(1)<0.5) & (size(3)>0.5) [symbol] t=6

In a similar manner to the step a9, this classification of the deterioration of the signal affected by noise taken into account to calculate the objective score of the signal affected by noise produces a result closer to the corresponding subjective score than if this classification were not to be taken into account.

In a step b10, an intermediate objective NOS score is calculated from the following linear combination:

$$NOS = ( {\sum }_{i = 1}^{4} ω ( i , t ) * deg ( i ) ) + ω ( 5 , t ) * Standard\_deviation ( {d}_{XbX} ( m , b ) ) + ω ( 6 , t ) * {( {dc}_{XXb} )}_{DAV = 1} + ω ( 7 , t )$$

where:

the parameters deg(i) are those obtained after the step b8;

the operator “Standard_deviation(z(m,b))” designates the standard deviation of the variable z(m,b) over all frames m and critical bands b;

* symbolizes the multiplication operator in the space of real numbers;

+ symbolizes the addition operator in the space of real numbers;

d_{XbX}(m,b) are the mean distance values calculated in the step b5;

(dc_{XXb})_{DAV=1} designates the mean cepstral distance between the signals x[m] and xb[m] calculated for the speech frames of those signals; and

the coefficients ω(1,t) to ω(7,t) are weighting coefficients predefined as a function of each of the six deterioration classes t.

These coefficients were determined to produce a maximum correlation between the subjective data from a subjective test database and the objective NOS scores calculated using this linear combination and the test signals x[m] and the signals affected by noise xb[m] employed during the same subjective tests and representative of the six classes of deterioration defined in the step b9. Just as for the step a10, obtaining weighting coefficients using a subjective test database is not indispensable at each stage of calculating an objective NOS score.

Finally, in a final step b11, an objective NOS_MOS score on the MOS scale for the signal affected by noise is calculated, for example using a third order polynomial function and the following equation:

$$NOS\_MOS = {\sum }_{i = 1}^{4} λ ( i , t ) {( NOS )}^{i - 1}$$

in which the coefficients λ(1,t) to λ(4,t) are determined for each deterioration class t of the signal affected by noise so that the objective NOS_MOS score obtained characterizes the signal affected by noise on the MOS scale, i.e. on a scale from 1 to 5.

Calculation of the perceived loudness densities and the hybrid masking threshold of a frame of an audio signal in the steps a3, a4, b3, and b4 and calculation of the cepstral distance between two frames of two audio signals in the steps a10 and b10 are described below with reference to FIG. 4, which represents a preferred implementation of the invention.

In the steps c1 to c10 represented in FIG. 4 and explained below:

calculation in accordance with the invention of the perceived loudness densities S_{U}(m,b) of a frame of any index m of a given audio signal u[m] comprises the steps c1 to c6;

calculation in accordance with the invention of the hybrid masking threshold of a frame of any index m of a given audio signal u[m] comprises the steps c1 to c5 and c7 to c9; and

calculation in accordance with the invention of the cepstral distance dc_uv[m] between a frame of any index m of a given audio signal u[m] and the frame of index m of another given audio signal v[m] comprises the steps c1 and c10.

A frame with any index m of a signal u[m] and the frame m of a signal v[m] are considered below, in the knowledge that some or all of the frames of the signals considered undergo the same processing. The signals u[m] and v[m] represent any of the signals x[m], xb[m] or y[m] defined above.

In the step c1, windowing is applied to the frames of index m of the signals u[m] and v[m], for example Hanning, Hamming or equivalent type windowing. Two windowed frames u_w[m] and v_w[m] are then obtained.

Following the step c1, for example during the step a3 for calculating the cepstral distance dc_xy[m], there follows the step c10, then the step c2 for calculating the perceived loudness densities and the hybrid masking thresholds of the signals x[m] and y[m], which are needed for the step a3. In contrast, during the step a3, for the signal xb[m], there is a direct passage from the step c1 to the step c2 for calculating the perceived loudness densities of the signal xb[m] over the frame of index m, for example.

In the next step c2, a fast Fourier transform (FFT) is applied to the windowed frame u_w[m] to obtain a corresponding frame U(m,f) in the frequency domain.

In the next step c3, the spectral power density Y_{U}u(m,f) of the frame U(m,f) is calculated. This kind of calculation is known to the person skilled in the art and consequently is not described in detail here.

In the step c4, a conversion from the frequency axis to the Barks scale is effected on the power spectral density Y_{U}(m,f) obtained in the preceding step to obtain a power spectral density B_{U}(m,b) on the Barks scale, also called the Bark spectrum. For a sampling frequency of 8 kHz, 18 critical bands must be considered. This type of conversion is familiar to the person skilled in the art, and the basic principle of Hertz/Bark conversion consists in adding all the frequency contributions present in the Barks scale critical band in question.

Thereafter, in the step c5, convolution with the spreading function, commonly used in psychoacoustics, is effected on the power spectral density B_{U}(m,b) on the Barks scale to obtain a spread spectral density E_{U}(m,b) on the Barks scale. The spreading function is formulated mathematically and one possible expression for it is:

$$10 log 10 ( E ( b ) ) = 15.81 + 7.5 * ( b + 0.474 ) - 17.5 * \sqrt{( 1 + {( b + 0.474 )}^{2} )} ;$$

where E(b) is the spreading function applied to the Barks scale critical band b in question and * symbolizes the multiplication operator in the space of real numbers. This step takes into account the interaction of adjacent critical bands.

After the step c5, for example in the step a3, for the signals x[m] and y[m], there follow the steps c7 to c9 for calculating the hybrid masking thresholds of the signals x[m] and y[m], then the step c6 for calculating the perceived loudness densities of those signals, as both calculations are necessary for both signals. In contrast, during the step a3, for the signal xb[m], there is a direct passage to the step c6 for calculating the perceived loudness densities, for example.

In the step c6, the spread spectral power density E_{U}(m,b) obtained previously is converted into perceived loudness densities expressed in sones. To this end the spread spectral density E_{U}(m,b) on the Barks scale is calibrated by the respective power and perceived loudness spreading factors commonly used in psychoacoustics. The document ITU-T Recommendation P.862, sections 10.2.1.3 and 10.2.1.4, gives an example of such calibration for the aforementioned factors. The magnitude obtained is then converted to the phones scale. Conversion to the phones scale is effected using curves of equal loudness (Fletcher curves) conforming to ISO standard 226 “Normal equal-loudness-level contours”. The magnitude previously converted into phones is then converted to the perceived loudness scale. The conversion into sones is effected in accordance with Zwicker's law, whereby:

$$N ( sone ) = {2}^{( \frac{N ( phone ) - 40}{10} )}$$

For more information on phone/sone conversion, see the document “PSYCHOACOUSTIQUE, L'oreille recepteur d'information”, E. Zwicker and R. Feldtkeller, Masson, 1981.

Following the step c6, as many perceived loudness density values, S_{U}(m,b) of the frame of index m for the critical band b are available as critical bands on the Barks scale are considered, b being the critical band index.

This last step c6 of calculating perceived loudness densities corresponds to conversion from the Barks domain to the Sones domain, enabling calculation of a subjective intensity, i.e. an intensity as perceived by the human ear.

In the step c7, the tonality coefficient α(m) of the frame of index m is calculated from the following equation, in which * symbolizes the multiplication operator in the space of real numbers, f represents the frequency index of the power spectral density, and N designates the size of the fast Fourier transform:

$$α ( m ) = \frac{10 * log 10 ( \frac{{( {\prod }_{f = 0}^{N - 1} {γ}_{U} ( m , f ) )}^{1 / N}}{\frac{1}{N} {\sum }_{f = 0}^{N - 1} {γ}_{U} ( m , f )} )}{- 60}$$

This calculation is effected in accordance with the principle defined by J. D. Johnston in his paper “Transform coding of audio signals using perceptual noise criteria” in IEEE Journal on selected areas in communications, Vol. 6, No. 2, February 1988.

The tonality coefficient a of a base signal is a measurement for showing if the signal contains certain pure frequencies. It is equivalent to a tonal density. The closer the tonality coefficient α is to 0, the more similar the signal is to noise. Conversely, the closer the tonality coefficient α is to 1, the more the signal has a majority tonal component. A tonality coefficient a close to 1 therefore bears witness to the presence of wanted signal, or speech signal.

In the next step c8, correction thresholds O(m,b) are calculated for each critical band b of the frame m, taking account of the asymmetry between the masking of a tone by noise and of noise by a tone. The level of correction applied to the spread spectrum therefore depends on the harmonic or non-harmonic nature of the signal as determined by the tonality coefficient α(m) previously calculated. An expression for the correction threshold O(m,b) in accordance with the invention is the formula:

O(m,b)=α(m)TMN_{ISO}(b)+(1−α(m))NMT_{ISO}(b)

where

αa(m) is the tonality coefficient calculated in the step c7;

TMN_{ISO}(b), where TMN stands for tone masking noise, is the correction value in decibels to be applied to the critical band b in the case of a tone masking noise, according to psychoacoustic model number 1 of the ISO (International Standards Organization) standard used in MPEG-2 ISO/MPEG IS-11172 coding; and

NMT_{ISO}(b), where NMT stands for noise masking tone, is the corrective value in decibels to be applied to the critical band b in the case of noise masking a tone, according to the same psychoacoustic model.

In the next step c9 the hybrid masking thresholds are calculated for each critical band b for the frame of the signal u[m]. The hybrid masking thresholds T_{U}(m,b) are given by the following equation:

T_{U}(m,b)=min((E_{U}(m,b)−O(m,b)),β(b))

where

min(p,q) is the minimum of the variables p and q;

E_{U}(m,b) is the spread spectral density calculated in the step c5;

O(m,b) is the correction threshold calculated in the step c8 for the critical band b;

β(b) is the absolute threshold of hearing for the critical band b.

Calculation of the hybrid masking thresholds T_{U}(m,b) in accordance with the invention uses a hybrid model somewhere between psychoacoustic model number 1 of the ISO standard and the Johnston model described in the paper cited above, in that the tonality coefficient used is that defined in the Johnston model, whereas the corrective values TMN_{ISO}(b) and NMT_{ISO}(b) used are those defined in the ISO standard. This avoids the arithmetical complexity of calculating the tonal coefficient according to the model of the ISO standard, which differs for each critical band b. This lightens the calculation load of the method of the invention. For more information on calculating these hybrid masking thresholds, see the thesis by Valérie Turbin submitted to the Center National d'Etudes des Télécommunications in December 1998 under the title “Combinaison du filtrage adaptatif et du filtrage optimal pour réaliser l'annulation d'écho acoustique dans le contexte de téléconférence”.

Finally, the cepstral distance dc_uv[m] is calculated in the step c10. To this end the respective cepstral coefficients {cᵢ} and {c′ᵢ} of the frame of index m of the signal u[m] and the frame of index m of the signal v[m] given by the following equations are calculated:

$$\begin{matrix}∀ i > 0 , & {c}_{i} = - {a}_{i} - {\sum }_{k = 1}^{i - 1} ( 1 - \frac{k}{i} ) {c}_{i - k} {a}_{k} & and {c}_{i} = {c}_{- i} \\ ∀ i > 0 , & {c}_{i}^{′} = - {a}_{i}^{′} - {\sum }_{k = 1}^{i - 1} ( 1 - \frac{k}{i} ) {c}_{i - k}^{′} {a}_{k}^{′} & and {c}_{i}^{′} = {c}_{- 1}^{′} \\ & {c}_{0} = log ( {σ}^{2} ) & \\ & {c}_{0}^{′} = log ( {σ}^{′2} ) & \end{matrix}$$

where:

the coefficients {aᵢ} and {a′ᵢ} are the linear prediction coefficients of the tenth order LPC (linear predictive coding) analysis calculated for the frame of index m of the signal u[m] and the frame of index m of the signal v[m];

σ² is the power of the signal u[m] measured on the frame of index m of the signal u[m];

σ′² is the power of the signal v[m] measured on the frame of index m of the signal v[m].

The cepstral distance dc_uv[m] is therefore calculated using the following formula:

$$dc\_uv [ m ] = {\sum }_{i = - N}^{N} {( {c}_{i} - {c}_{i}^{′} )}^{2}$$

the number N being taken as twice the order of the auto-regressive LPC analysis model. In practice, the energy difference (c₀-c′₀)² is not taken into account in the calculation as it is of no great significance on the perceptual plane.

Note that in steps a10 and b10 the average of the cepstral distances dc_xy[m] and dc_xxb[m] is calculated. Considered over a period of time, the cepstral distance dc_xy[m], for example, visualizes the temporal distribution of the deterioration of the processed signal y[m] relative to the test signal x[m]. The mean value (dc_{XY})_{DAV=1} of the cepstral distances dc_xy[m] of the speech frames produces a unique score for the processed signal y[m]. For more details on the calculation and significance of the cepstral distance, see the thesis of Christophe Veaux presented to the Ecole Nationale Supérieure des Télécommunications on 20 Jan. 2005 and entitled “Etude de traitements en réception pour l'amélioration de la qualité de la parole”.

Note also that in the implementations of the method according to the invention described above, the order of the steps a1 to a11 and b1 to b11 is given by way of example. This order can be modified according to whether the results obtained after a step are used again in the next step or a later step, enabling even more implementations to be produced. Thus the result of voice activity detection in the step a2 is used only from step a8, the masking threshold calculated in the step a4 is used only in the step a6, the cepstral distance between the signals x[m] and y[m] calculated in the step a3 is used only in step a10, and the step a9 is independent of the steps a7 and a8. A variant of the first implementation of the method of the invention therefore includes steps, for example in the same order as in the list: {a1, a3, a5, a6, a9, a7, a2, a8, a10, a11}, with the cepstral distance between the signals x[m] and y[m] calculated in the step a10 instead of in the step a3.

1. A method of calculating an objective score (NOS) of the perceived quality of an audio signal degraded by the presence of noise and processed by a noise reducing function, said method comprising a preliminary step of obtaining a predefined test audio signal (x[m]) containing a wanted signal free of noise, a signal (xb[m]) affected by noise obtained by adding a predefined noise signal to the test signal (x[m]), and a processed signal (y[m]) obtained by applying the noise reducing function to the signal (xb[m]) affected by noise, said method further comprising:
a step (a5) of measuring distances (d_{YX}(m,b)) between perceived loudness densities calculated for the processed signal (y[m]) and perceived loudness densities calculated for the test signal (x[m]); and
a step (a6) of comparing said distances (d_{YX}(m,b)) with masking thresholds (S_{masking}(m,b)) calculated for the test signal (x[m]) and/or the processed signal (y[m]).

2. The method according to claim 1, further comprising the steps of:
detecting (a2) voice activity in the test signal (x[m]);
calculating (a3) perceived loudness densities for the processed signal (y[m]), the signal (xb[m]) affected by noise, and the test signal (x[m]);
calculating (a4) masking thresholds (S_{masking}(m,b)) for the processed signal (y[m]) and/or the test signal (x[m]);
calculating (a5) the distances (d_{YX}(m,b)) between said perceived loudness densities of the processed signal (y[m]) and said perceived loudness densities of the test signal (x[m]) and the distances (d_{XbY}(m,b)) between said perceived loudness densities of the processed signal (y[m]) and said perceived loudness densities of the signal (xb[m]) affected by noise;
partitioning (a6) the distances (d_{YX}(m,b)) calculated in this way between said perceived loudness densities of the processed signal (y[m]) and said perceived loudness densities of the test signal (x[m]) by comparison with said masking thresholds (S_{masking}(m,b));
calculating (a8) mean values of the distances (d_{YX}(m,b)) partitioned in this way as a function of said partitioning and the result of the voice activity detection (VAD[m]) in order to obtain parameters (deg(1), deg(2), deg(3), deg(4)) characteristic of different types of deterioration caused by noise in the processed signal (y[m]); and
calculating (a10) an objective score for the processed signal (y[m]) using the parameters (deg(1), deg(2), deg(3), deg(4)) obtained in this way, the distances (d_{YX}(m,b), d_{XbY}(m,b)) calculated in the distance calculation step (a5), and subjective data obtained from a test database.

3. A method of calculating an objective score (NOS) of the perceived quality of an audio signal degraded by the presence of noise, said method comprising a preliminary step of obtaining a predefined test audio signal (x[m]) containing a wanted signal free of noise and a signal (xb[m]) affected by noise obtained by adding a predefined noise signal to the test signal (x[m]), said method further comprising:
a step (b5) of measuring distances (d_{XbX}(m,b)) between perceived loudness densities calculated for the signal affected by noise (xb[m]) and perceived loudness densities calculated for the test signal (x[m]); and
a step (b6) of comparing said distances (d_{XbX}(m,b)) with masking thresholds (S_{masking}(m,b)) calculated for the signal affected by noise (xb[m]) and/or the test signal (x[m]).

4. The method according to claim 3, further comprising the steps of:
detecting (b2) voice activity in the test signal (x[m]);
calculating (b3) perceived loudness densities for the signal (xb[m]) affected by noise and the test signal (x[m]);
calculating (b4) masking thresholds (S_{masking}(m,b)) for the signal affected by noise (xb[m]) and/or the test signal (x[m]);
calculating (b5) the distances (d_{XbX}(m,b)) between said perceived loudness densities of the test signal (x[m]) and said perceived loudness densities of the signal (xb[m]) affected by noise;
partitioning (b6) the distances (d_{XbX}(m,b)) calculated in this way by comparison with said masking thresholds (S_{masking}(m,b));
calculating (b8) mean values of the distances (d_{XbX}(m,b)) partitioned in this way as a function of said partitioning and the result of the voice activity detection (VAD[m]) in order to obtain parameters (deg(1), deg(2), deg(3), deg(4)) characteristic of different types of deterioration caused by noise in the signal affected by noise (xb[m]); and
calculating (b10) an objective score (NOS) for the signal affected by noise (xb[m]) using the parameters (deg(1), deg(2), deg(3), deg(4)) obtained in this way, the distances (d_{XbX}(m,b)) calculated in this way, and subjective data obtained from a test database.

5. The method according to claim 4, wherein the partitioning step (a6, b6) is followed by a step (a9, b9) of classifying the degraded audio signal as a function of the types of deterioration present in said signal, the calculation of the objective score (NOS) taking account of this classification (t).

6. The method according to claim 4, wherein the step (a8, b8) of calculating mean values is preceded by a step (a7, b7) of changing the frame timing.

7. The method according to claim 4, wherein the step (a10, b10) of calculating the objective score (NOS) is followed by a step (a11, b11) of calculating an objective score (NOS_MOS) on the MOS scale of the perceived quality of the audio signal degraded by the presence of noise.

8. The method according to claim 4, wherein the calculation of the masking thresholds (S_{masking}(m,b)) of a frame of the audio signal uses a model that is a hybrid of the Johnston masking model and the ISO (International Standards Organization) masking model.

9. A test device adapted to evaluate an objective score (NOS) of the perceived quality of an audio signal degraded by the presence of noise, comprising means adapted to implement a method according to claim 1.

10. An information medium for storing a computer program that it that includes instructions adapted to implement a method according to claim 1 when said program is loaded into and executed by a data processing system.

11. The method according to claim 2, wherein the partitioning step (a6, b6) is followed by a step (a9, b9) of classifying the degraded audio signal as a function of the types of deterioration present in said signal, the calculation of the objective score (NOS) taking account of this classification (t).

12. The method according to claim 2, wherein the step (a8, b8) of calculating mean values is preceded by a step (a7, b7) of changing the frame timing.

13. The method according to claim 2, wherein the step (a10, b10) of calculating the objective score (NOS) is followed by a step (a11, b11) of calculating an objective score (NOS_MOS) on the MOS scale of the perceived quality of the audio signal degraded by the presence of noise.

14. The method according to claim 2, wherein the calculation of the masking thresholds (S_{masking}(m,b)) of a frame of the audio signal uses a model that is a hybrid of the Johnston masking model and the ISO (International Standards Organization) masking model.

15. A test device adapted to evaluate an objective score (NOS) of the perceived quality of an audio signal degraded by the presence of noise, comprising means adapted to implement a method according to claim 3.

16. An information medium for storing a computer program that includes instructions adapted to implement a method according to claim 3 when said program is loaded into and executed by a data processing system.
